(19) United States
(12) Patent Application Publication
(10) Pub. No.: US 2004/0262433 A1
(43) Pub. Date: Dec. 30, 2004

(54) Freely swinging self-levelling spray boom

(76) Inventor: H. William B. Wilt, Valleyview (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/875,996

(22) Filed: Jun. 24, 2004

(30) Foreign Application Priority Data
Jun. 25, 2003 (CA) 2,433,293

(51) Int. Cl. B05B 1/20; B05B 3/00; B05B 3/18

(52) U.S. Cl. 239/722; 239/723; 239/725; 239/726

(57) ABSTRACT

A freely swinging self-levelling spray boom includes a support structure and a mounting adapted to mount the support structure to a vehicle to swing freely about a pivot axis lying in a direction of travel of the vehicle. A spray boom is supported by the support structure. A tank adapted to hold liquid spray medium is supported by the support structure. The tank is symmetrically mounted to the support structure relative to the pivot axis. The weight provided by the tank and the liquid spray medium it contains serves to maintain the support structure and the spray boom in a substantially horizontal orientation when the vehicle is traversing a slope and dampen oscillations of the spray boom.

### FIELD OF THE INVENTION

The present invention relates to a freely swinging self-levelling spray boom.

### BACKGROUND OF THE INVENTION

German Patent specification 1,181,485 discloses a freely swinging self-levelling spray boom. The spray boom is suspended from a vehicle to swing freely about an axis lying in a direction of travel of the vehicle. As described in U.S. Pat. No. 3,731,879 (Hoegen Dijkhof 1973), the free swinging of the spray boom has some inherent drawbacks. There are, therefore, a number of patents, such as the Hoegen Dijkhof patent which focus upon controlling the swinging movement of the spray boom through the use of counter-weights or dampening springs.

### SUMMARY OF THE INVENTION

What is required is an alternative embodiment of freely swinging self-levelling spray boom.

According to the present invention there is provided a freely swinging self-levelling spray boom includes a support structure and a mounting adapted to mount the support structure to a vehicle to swing freely about a pivot axis lying in a direction of travel of the vehicle. A spray boom is supported by the support structure. A tank adapted to hold liquid spray medium is supported by the support structure. The tank is symmetrically mounted to the support structure relative to the pivot axis. The weight provided by the tank and the liquid spray medium it contains serves to maintain the support structure and the spray boom in a substantially horizontal orientation when the vehicle is traversing a slope and dampen oscillations of the spray boom.

Although beneficial results may be obtained through the use of the freely swinging self-levelling spray boom, as described above, clearance problems are encountered when the spray boom always maintains a horizontal orientation on a slope. Even more beneficial results may, therefore, be obtained when the spray boom is pivotally mounted to the support structure by support arms. The support arms pivot about substantially horizontal pivot axes oriented transverse to the direction of travel of the vehicle. The pivoting of the support arms serves to raise or lower the spray boom relative to the support structure in order to obtain required clearance to clear fences and other obstacles.

Although beneficial results may be obtained through the use of the freely swinging self-levelling spray boom, as described above, even more beneficial results may be obtained when a pump assembly is supported by the support structure. The pump assembly is adapted to pump the liquid spray medium drawn from the tank along the spray boom. When such a pump assembly is provided, the freely swinging self-levelling spray boom does not have to draw upon the systems of the vehicle.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of a freely swinging self-levelling spray boom constructed according to the teachings of the present invention.

FIG. 2 is a rear elevation view of the freely swinging self-levelling spray boom illustrated in FIG. 1.

### DETAILED DESCRIPTION OF THE PREFERRED EMBODIMENT

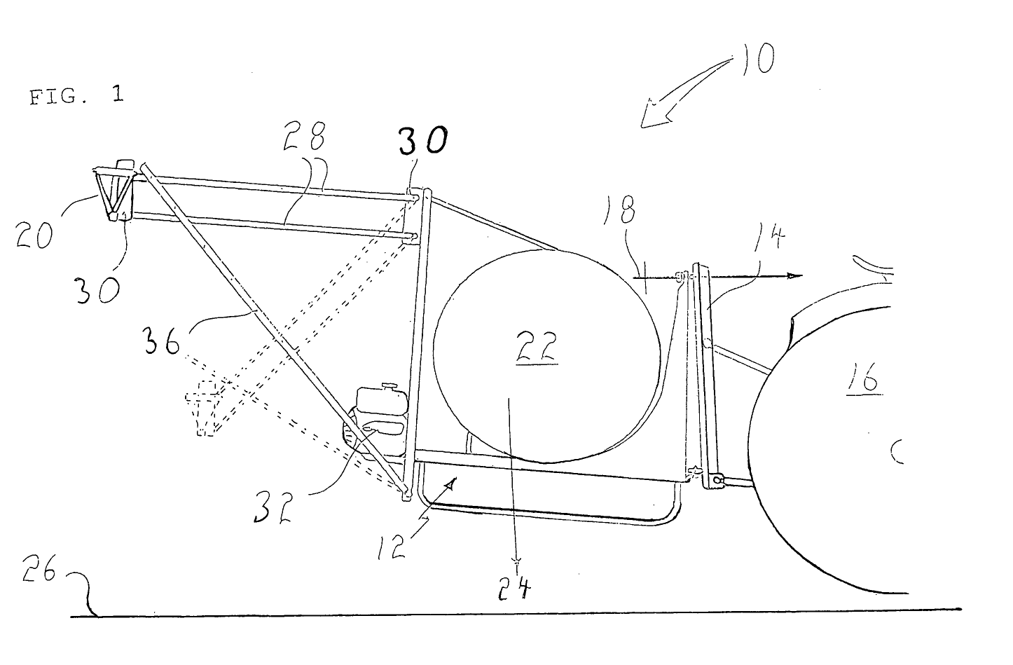

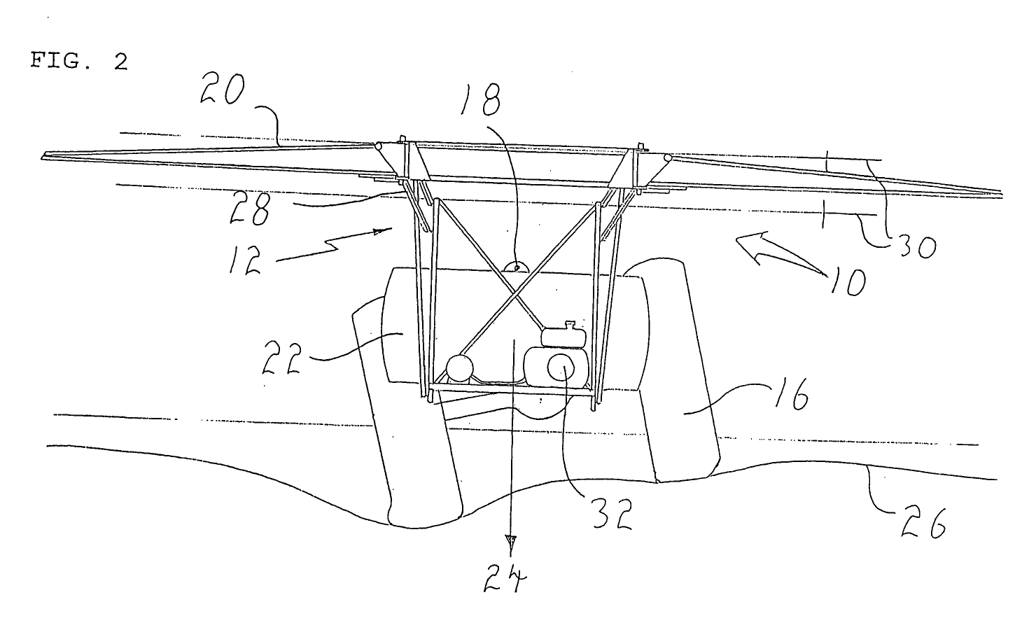

The preferred embodiment, a freely swinging self-levelling spray boom generally identified by reference numeral 10, will now be described with reference to FIGS. 1 through 2.

Structure and Relationship of Parts:

Referring to FIG. 1, self-levelling spray boom 10 has a support structure 12. A mounting 14 is adapted to mount support structure 12 to a vehicle 16 such that support structure 12 swings freely about a pivot axis 18 lying in a direction of travel of vehicle 16. Referring to FIG. 2, a spray boom 20 is supported by support structure 12. A tank 22, adapted to hold liquid spray medium, is symmetrically mounted to support structure 12 relative to pivot axis 18 such that weight 24 provided by tank 22 and the liquid spray medium it contains serves to maintain support structure 12 and spray boom 20 in a substantially horizontal orientation to a ground surface 26. Referring to FIG. 1, in the illustrated embodiment, boom 20 is attached to support structure 12 by support arms 28. Referring to FIG. 2, support arms 28 pivot about substantially horizontal pivot axes 30, oriented transverse to the direction of travel of vehicle 16. In the illustrated embodiment, a pump assembly 32, adapted to pump the liquid spray medium drawn from the tank along the spray boom, is also supported by support structure 12.

Operation:

The use and operation of freely swinging self-levelling spray boom 10, will now be described with reference to FIGS. 1 through 2. Referring to FIG. 1, boom 20, tank 22 and pump apparatus 32 are all supported by support structure 12. Support structure 12 is, in turn, mounted to mounting 14 on vehicle 16 such that a pivot axis 18 is created above the center of gravity of weight 24. Referring to FIG. 2, as a result, support structure 12 along with tank 22 and boom 20, swing and adapt to ground 26 according to the force of weight 24. The use of tank 22 filled with liquid spray medium enhances dampening of any oscillations in spray boom 20 as a result of uneven ground. By having pump apparatus 32 also supported by support structure 12, stability is further enhanced and the entire assembly is self-contained. Referring to FIG. 1, in the illustrated embodiment, where an operator needs to adjust the height of boom 20, arms 28 allow for adjustment. In the illustrated embodiment, selectively positioned holes with pins 36 are be used. It will be appreciated that various mechanical means of adjustment may be used, such as hydraulic actuators.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The Embodiments of the Invention in which an Exclusive Property or Privilege is Claimed are Defined as follows:

1. A freely swinging self-levelling spray boom, comprising:
a support structure;
a mounting adapted to mount the support structure to a vehicle to swing freely about a pivot axis lying in a direction of travel of the vehicle;
a spray boom supported by the support structure;
a tank adapted to hold liquid spray medium supported by the support structure, the tank being symmetrically mounted to the support structure relative to the pivot axis, such that weight provided by the tank and the liquid spray medium it contains serves to maintain the support structure and the spray boom in a substantially horizontal orientation when the vehicle is traversing a slope and dampen oscillations of the spray boom.

2. The freely swinging self-levelling spray boom as defined in claim 1, wherein the spray boom is pivotally mounted to the support structure by support arms, the support arms pivoting about substantially horizontal pivot axes oriented transverse to the direction of travel of the vehicle, the pivoting of the support arms serving to raise or lower the spray boom relative to the support structure.

3. The freely swinging self-levelling spray boom as defined in claim 1, wherein a pump assembly is supported by the support structure, the pump assembly being adapted to pump the liquid spray medium drawn from the tank along the spray boom.
